(19) United States
(12) Patent Application Publication
(10) Pub. No.: US 2004/0015611 A1
(43) Pub. Date: Jan. 22, 2004

(54) Interfaces to multiple layers of device properties in a storage network

(76) Inventor: Hyon T. Kim, San Jose, CA (US)

Correspondence Address: Robert C. Kowert, Conley, Rose, & Tayon, P.C., P.O. Box 398, Austin, TX, 78767, US

(21) Appl. No.: 10/180,830

(22) Filed: Jun. 25, 2002

(51) Int. Cl. G06F 15/16

(52) U.S. Cl. 709/250

(57) ABSTRACT

A host may be coupled to a fabric network. Fabric devices attached to the fabric network may be visible to the host through one or more host adapter ports. An interface may be configured to provide layer-specific device property information. The interface may be configured to obtain device property information for the devices attached to the fabric network from the fabric driver and return the device property information specific to one of the plurality of protocol layers. The protocol layers may include a transport layer and an end device target layer. An application may be any process running on the host that may request information about device properties via an interface (e.g., one or more application programming interfaces (APIs)). These interfaces may be configured to return the layer-specific device property information for multiple layers of device properties.

### BACKGROUND

1. Field of the Invention

This invention relates to network systems, and more particularly to interfaces to multiple layers of device properties in a storage network.

2. Description of the Related Art

Storage area networks, also referred to as SANs, are dedicated networks that connect one or more systems to storage devices and subsystems. Today, fibre channel is one of the leading technologies for SANs. In general, fibre channel encompasses three networking topologies: point-to-point, loop, and fabric. In a point-to-point topology, a fibre channel host adapter in a system is typically connected to a single fibre channel storage subsystem. In a fibre channel loop network, also called an arbitrated loop, the loop is constructed by connecting devices together in a single logical ring. Loops can be constructed by connecting devices through a fibre channel hub in a star-wired topology or by connecting them together in a connected physical loop from device to device. In a fibre channel fabric topology, the storage networks are constructed with network switches. A fabric can be composed of a single switch or multiple switches. Ports on fabric networks connect devices to switches on low-latency, point-to-point connections.

The devices connected in the loop and fabric topologies may be any entity that is able to send or receive transmissions in a fibre channel network. For example, a device may be a computer system, a storage device/subsystem, a storage router/bridge that connects SCSI equipment, a printer, a scanner, or any other equipment such as data capture equipment. The ANSI X3.272-1996 specification entitled “FC-AL, Fibre Channel Arbitrated Loop” and the ANSI X3.T11 Project 1133-D specification entitled “FC-AL-2, Fibre Channel Arbitrated Loop” describe examples of fibre channel loop topologies in further detail. The ANSI X3.T11 Project 959-D specification entitled “FC-SW Fibre Channel Switch Fabric” describes an example of a fibre channel fabric in further detail. Note that the most recent versions of these and related specifications may be obtained from the T11 technical committee of the National Committee for Information Technology Standards (NCITS).

For SANs, multiple layers of device properties may exist. Properties may include, but are not limited to, port name, device type and port address. The properties of a device may be categorized for each layer, such as a transport layer or an end target device layer for devices within the network environment. Fabric drivers executing on a host computer may discover the devices attached to the network that are accessible to the host computer. The discovered devices may be configured to be accessible to applications running on the host. The applications may obtain information about device properties from the fabric drivers and/or other mechanisms on the host. In conventional systems, the information is provided collectively for multiple layers of device properties. If an error occurs on one of the layers, conventional systems return an error without any information from the other layers.

### SUMMARY

A host system may have one or more host adapter ports for coupling the host system to a fabric network. Devices attached to the fabric network may be discoverable to the system through the one or more host adapter ports. The host system may include a fabric driver configured to interface the host system to the fabric network through the host adapter ports. The fabric driver may provide access to the fabric network according to a plurality of protocol layers. The plurality of protocol layers may comprise a transport layer and an end target device layer. The transport layer may comprise at least one of a Fibre Channel transport layer, an InfiniBand transport player and an iSCSI transport layer, and the end target device layer may comprise a SCSI device layer.

An application may be any process running on the host system that may request information about device properties via an interface (e.g., one or more application programming interfaces (APIs)). These interfaces may be configured to return layer-specific information for multiple layers of device properties. These interfaces may be configured to obtain device property information for the devices attached to the fabric network from the fabric driver and return the device property information specific to one of the plurality of protocol layers.

One interface may return the protocol layers. One interface may return the property names, or the property types for the property names, associated with the protocol layer. In one embodiment, for a Fibre Channel transport protocol layer, the property names returned by an interface may be port world wide name (WWN), node WWN, port address and hard address. For an end target device protocol layer, the property names returned by an interface may be device type, logical unit number and storage capacity. Another interface may return actual property data, or an error, associated with the protocol layer.

[symbol]

### BRIEF DESCRIPTION OF THE DRAWINGS

FIG. 1 illustrates a host computer attached to a fabric and one or more local devices;

FIG. 2 illustrates an example of a storage area network (SAN) suitable for implementing various embodiments;

FIG. 3 is an example of a storage network suitable for implementing various embodiments;

FIG. 4 is an illustration of a host computer coupled to a fabric according to one embodiment;

FIG. 5 is an illustration of a fabric driver with various modules according to one embodiment;

FIG. 6 is an illustration of various interfaces to a fabric driver according to an embodiment;

FIG. 7 is a flowchart of a process to provide transport layer information for multiple layers of device properties, according to one embodiment;

FIG. 8 is a flowchart of a process to provide property name information for multiple layers of device properties according to an embodiment;

FIG. 9 is a flowchart of a process to provide property type information for multiple layers of device properties according to one embodiment;

FIG. 10 is a flowchart of a process to provide property data information for multiple layers of device properties according to one embodiment;

FIG. 11 is a flowchart of a process to provide property information for multiple layers of device properties to an application according to one embodiment; and

FIG. 12 is a flowchart of an on-demand node configuration process according to one embodiment.

While the invention is described herein by way of example for several embodiments and illustrative drawings, those skilled in the art will recognize the invention is not limited to the embodiments or drawings described. It should be understood that the drawings and detailed description thereto are not intended to limit the invention to the particular form disclosed, but on the contrary, the intention is to cover all modifications, equivalents and alternatives falling within the spirit and scope of the invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

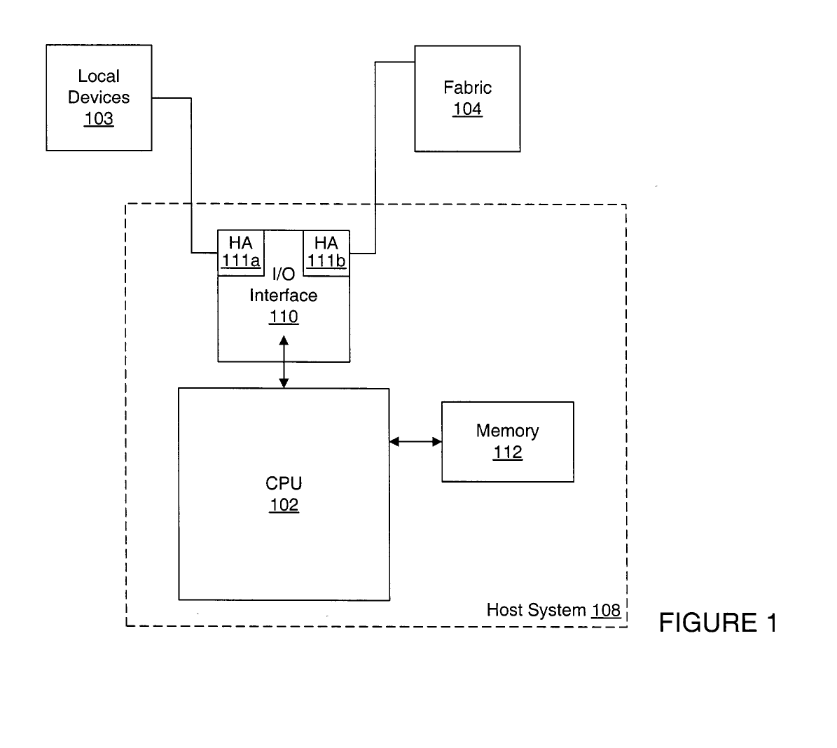

Suitable for implementing various embodiments, FIG. 1 illustrates a host system 108 attached to a fabric 104. The host system may include at least one central processing unit (CPU) or processor 102. The CPU 102 may be coupled to a memory 112. The memory 112 is representative of various types of possible memory media, also referred to as “computer readable media”. Hard disk storage, floppy disk storage, removable disk storage, flash memory or random access memory (RAM) are examples of memory media. The terms “memory” and “memory medium” may include an installation medium, e.g., a CD-ROM or floppy disk, a computer system memory such as DRAM, SRAM, EDO RAM, SDRAM, DDR SDRAM, Rambus RAM, etc., or a non-volatile memory such as a magnetic media, e.g., a hard drive or optical storage. The memory medium may include other types of memory as well, or combinations thereof. In addition, the memory medium may be located in a first computer in which the programs are executed, or may be located in a second different computer which connects to the first computer over a network. In the latter instance, the second computer may provide the program instructions to the first computer for execution.

The memory 112 may permit two-way access: readable and writable. The memory 112 may store instructions and/or data which implement all or part of the system and method described in detail herein, and the memory 112 may be utilized to install the instructions and/or data. The host system 108 may be any of the various types of devices, including, but not limited to, a personal computer system, desktop computer, laptop computer, palmtop computer, mainframe computer system, workstation, network appliance, network computer, Internet appliance, personal digital assistant (PDA), embedded device, smart phone, television system, or other suitable device. In general, the term “computer system” may be broadly defined to encompass any device having a processor 102 which executes instructions from a memory medium.

The host system 108 may be coupled to a fabric 104, which may provide access to a plurality of fabric attached devices, such as persistent storage devices or other computer peripheral devices. The CPU 102 may acquire instructions and/or data through an input/output (I/O) interface 110. Through the input/output interface 110, the CPU 102 may also be coupled to one or more local devices 103, such as local input/output devices (video monitors or other displays, track balls, mice, keyboards, etc.) local storage devices (hard drives, optical storage devices, etc.), local printers, plotters, scanners, and any other type of local I/O devices for use with a host system 108. Some local devices 103 may be referred to as direct attach devices. The input/output interface 110 may include host adapters (HA) 111a and 111b for coupling to the local devices 103 and fabric respectively. Host adapters 111a and 111b may be fibre channel adapters (FCAs). In one embodiment, one or more of the local devices 103 may be included in the host system 108, such as in expansion slots of the host system 108. In one embodiment, one or more of the local devices 103 may be externally connected to the host system 108.

The host system 108 may be able to execute one or more computer programs. The computer programs may comprise an operating system (OS) or other system software, application software, utility software, Java™ applets, and/or any other sequence of instructions. Typically, an operating system performs basic tasks such as recognizing input from the keyboard, sending output to the display screen, keeping track of files and directories on the disk, and controlling peripheral devices such as disk drives and printers. Application software runs on top of the operating system and provides additional functionality. In one embodiment, the OS may be based on the Solaris™ operating system from Sun Microsystems, Inc. The computer programs may be stored in a memory medium or storage medium such as the memory 112. Alternatively, the computer programs may be provided to the CPU 102 through the fabric or input/output interface 110.

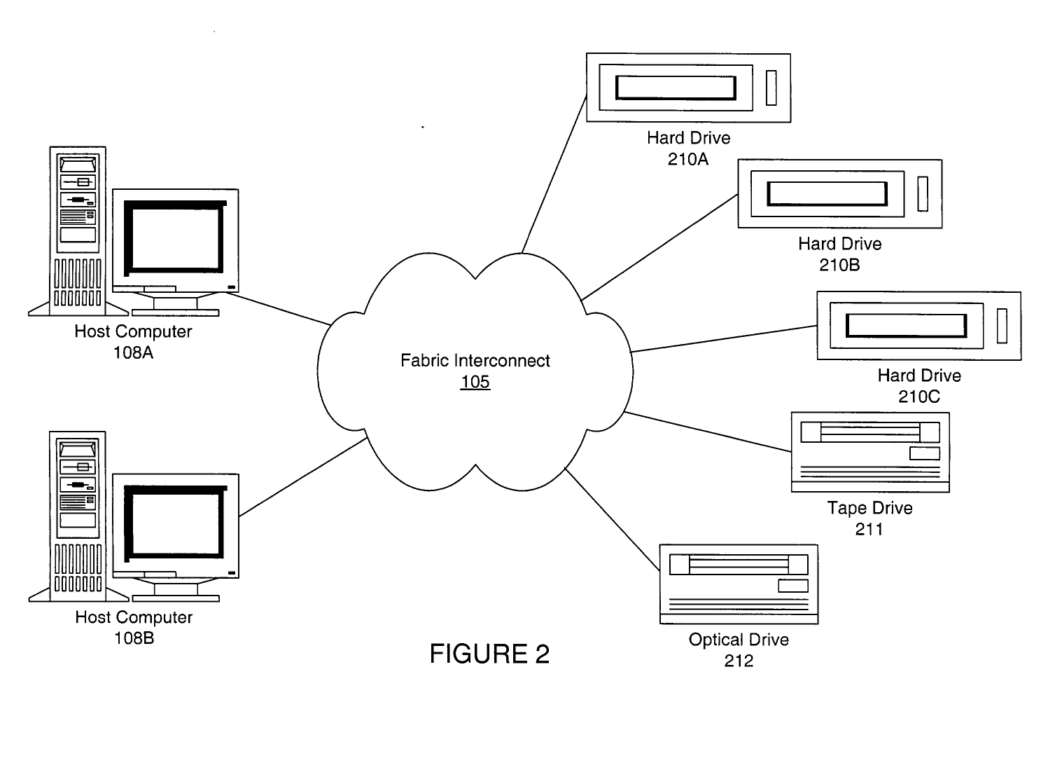

FIG. 2 illustrates an example of a storage area network (SAN) coupled to host computers 108A and 108B. The SAN includes a fabric interconnect 105 coupled to hard drives 210A, 210B, and 210C, tape drive 211, and optical drive 212. Hard drives 210A, 210B, and 210C, tape drive 211, and optical drive 212 may also be referred to as fabric devices. Each device may be coupled to one or more host computer through the fabric interconnect. A device may have multiple paths through the fabric to the same host or host adapter port. Also, several upper layer protocol (ULP) devices may share the same connection to the fabric. For example, hard drive 210A may be a drive array or JBOD including multiple hard drives or logical units coupled to the fabric through the same fabric connection. Note that the number and types of hosts and devices are for illustration purposes only, and the actual number and types of hosts and/or devices in a SAN may vary.

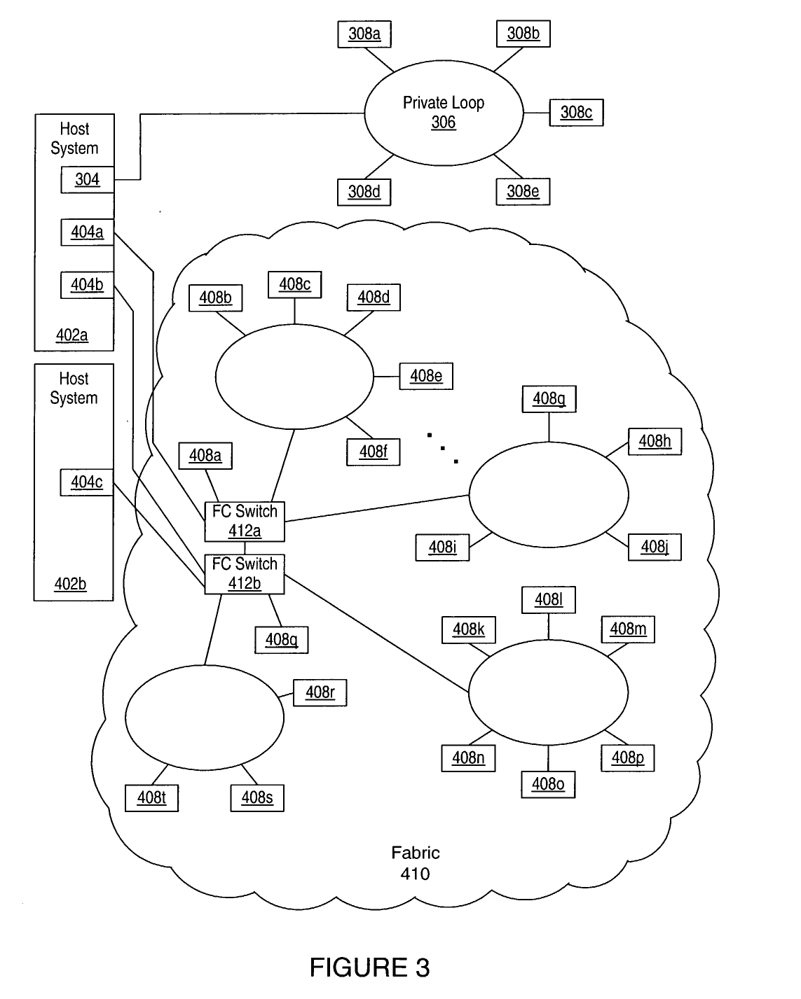

FIG. 3 illustrates a more detailed example of a storage network which includes a direct attached private loop 306 and a fabric 410. Note that storage networks may be configured in a variety of different ways and many include one or more direct attach devices, SANs, and/or network attach (NAS) devices. Furthermore, note that fabrics and/or SANs are not limited to fibre channel technologies and architectures but may include various types of technologies. For example, some or all of a SAN may be based on the InfiniBand™ architecture or Small Computer System Interface over IP (iSCSI).

Host adapter 304 couples host system 402a to private loop 306 and adapters 404a and 404b couple host system 402b to fabric 410. Note that host adapters 304, 404a and 404b may be separate host bus adapter cards, for example. In other embodiments, host adapters 304, 404a and 404b may each refer to a separate host adapter port. Coupled to private loop 306 are one or more direct attach devices 308. Direct attach device(s) are considered local to host system 402A.

The host system 402b may be coupled to fabric 410 via host adapter 404c. Fabric 410 may include fibre channel switches 412 which are coupled to multiple fabric devices 408. Each fibre channel switch 412 may connect to various fibre channel topologies such as point-to-point fibre channel connections or fibre channel loops. Each switch 412 may also connect to one or more other fibre channel switches. The fabric devices 408 may be various storage devices such as hard disk drives, optical drives, tape drives, etc. In some embodiments, fabric devices 408 may be any type of I/O device such as storage devices, printers, scanners, etc. as used in conjunction with computer systems.

Within fabric 410, a host or host adapter port may have multiple paths through the fabric to the same device. For example, FIG. 3 shows host system 402a having at least two paths to device 408a. One path is from 408a to switch 412a to host system 402a. Another path is from device 408a to switch 412a to switch 412b to host system 402a. In some embodiments, the same host adapter port may be able to reach a fabric device through several at least partially different paths within the fabric. In some embodiments, fabric 410 may include numerous switches and interconnects such that a host may have multiple paths to any number of devices within the fabric. Multiple paths may provide for redundancy in a host system's ability to communicate with a device.

Direct attach devices 308 and fabric devices 408 may have multiple layers of device properties. Device properties may include port name, node name, device type, device capacity, port address, etc. Specific properties may be associated with each layer such as a transport layer or an end target device layer. For example, port World Wide Name (WWN), node WWN, port address and hard address may be associated with the transport layer. Device type, Logical Unit Number (LUN) information and capacity may be associated with the end target device layer. Host computers 402a and 402b may discover the attached devices that are accessible to the host computers. The discovered devices may be configured to be accessible to applications running on the hosts. The applications may then request information for multiple layers of device properties.

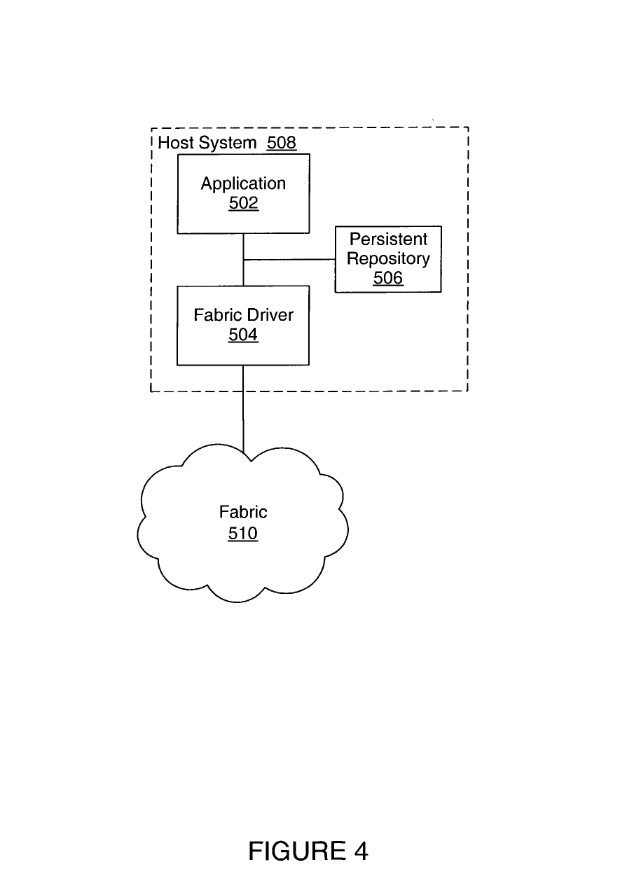

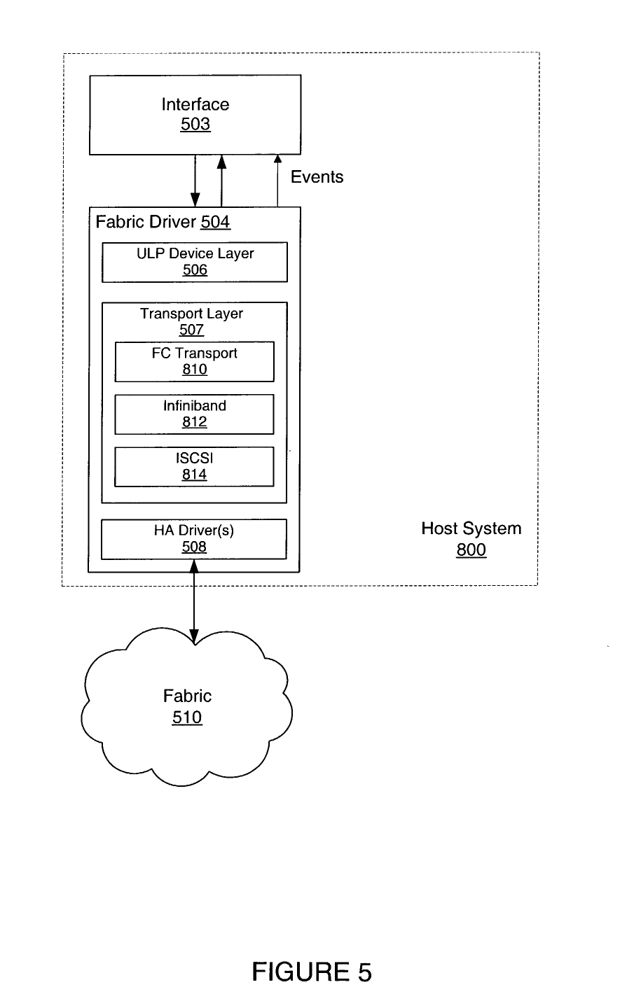

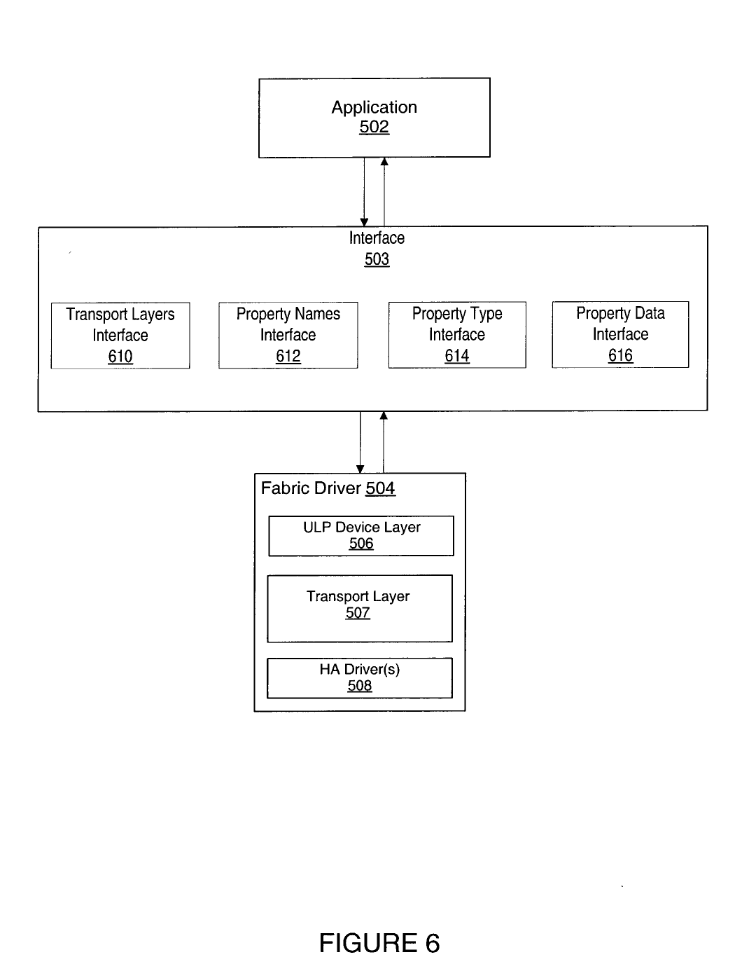

FIG. 4 illustrates a host system 508 coupled to a fabric 510 according to one embodiment. The fabric may be implemented with one or more switches coupled to one or more storage devices or subsystems. Furthermore, the fabric may not be limited to fibre channel fabrics but may be extended to any type of switched storage network with various network topologies. A fabric driver 504 may provide an interface between the host system 508 and fabric 510. A persistent repository 506 may be a data structure that stores information on the current configuration of the devices. In one embodiment, the persistent repository may store information for different layers of device properties for host system 508. An application 502 may be any process running on the host system 508 that may request information about device properties via an interface (e.g., one or more application programming interfaces (APIs)). These interfaces, as described below in FIGS. 5 and 6, may be configured to return the information for different layers of device properties.

The application 502 may be a software program running on the host system 508 and accessible to a user (e.g., system administrator, other process, etc.). For example, application 502 may be used by system administrators for configuring devices on-demand with user input, as opposed to discovering devices accessible to a host system 508 all at once during host boot-up or reconfiguration. Conversely, application 502 may be a software program not accessible to a user via a user interface. For example, application 502 may be an operating system process used to collect information about device properties and the operating system process may be accessible by other processes. Thus, certain events, or requests from other processes, may trigger application 502 to collect information for different layers of device properties.

The application 502 may query, through an interface, a fabric driver 504 for information about the devices accessible to the host system 508. In some embodiments, the query operations made by the application 502 to obtain device information may be made on a per host adapter port granularity or a set of host adapter ports granularity so that the information returned by the query may be more manageable. For example, a query operation may be used to obtain information associated with a particular layer of device properties on a per host adapter port granularity.

The fabric driver 504 may provide an interface for the host system 508 to the fabric 510. The fabric driver 504 may be part of the operating system for the host system 508 and may include one or more modules for handling various functions required to interface the host system 508 to the fabric 510 such as protocol handling and multiple layer operations. In one embodiment, the fabric driver 504 may be a Solaris kernel module or modules. The fabric driver 504 may provide the information associated with a particular layer of device properties to application 502 via one or more APIs configured to return information for different layers of device properties.

In one embodiment, a persistent repository 506 may be stored in the host system, or in some central locale accessible to the host system 508 indicating the current property information for the devices in the storage network. The persistent repository 506 may store property information for devices. The information stored in the persistent repository 506 may be used so the property information may persist across reboots and shutdowns. For example, when a host system storing a persistent repository of property information is rebooted, the persistent repository may be read to determine device properties and the fabric driver may be requested to provide access to these same devices again.

The persistent repository 506 may be dynamically updated to reflect the state of the fabric devices. For example, if a device which has access to a host system is disabled on the fabric (for example, a hard drive fails or an internal error occurs), the fabric driver may generate an event causing the persistent repository 506 to be updated to reflect that the device, or a particular path configuration for the device, is now inaccessible. Similarly, if the same device is later restored on the fabric, the device, or a particular path configuration for the device, may be configured for access again (e.g., in response to an event) and the persistent repository 506 may be dynamically updated to reflect the new communication status.

FIG. 5 illustrates a host system 800 coupled to a fabric 510 according to one embodiment. The host system 800 may include a fabric driver 504 for communicating with a fabric such as a fibre channel fabric. In another embodiment, the host system 800 may include a device driver for communicating with a direct attach device connected to the host. An interface 503 may be provided as an interface between the application 502 and the fabric driver 504. In one embodiment, the interface 503 may be part of the operating system libraries and may be usable by other applications on the host system. In further embodiments, the interface 503 may be part of a particular application residing on the host system and useable by other applications, or implemented as part of fabric driver 504.

In one embodiment, the interface 503 may include various APIs configured to provide layer-specific information for multiple layers of device properties. The APIs may be configured to execute a query to obtain the property information irrespective of the SAN technology and/or network topology of the host adapters. For example, the APIs may be used in a fibre channel switched fabric configuration or an Infiniband configuration. The APIs may be configured to provide information for different layers of device properties separately so applications may leverage the granular information based on an information need of the application.

For one embodiment, the fabric driver 504 may include various modules for interfacing the host system 800 to devices according to different protocol layers. Protocol layers may provide various mechanisms for transmitting data between devices and a host computer. Each protocol layer may define and provide specific operations for transmitting data based on a transmission hierarchy of operations among the layers. For example, the fabric driver 504 may include an upper layer protocol (ULP) device layer 506, which may be an end target device layer, that defines application interfaces as specific device-level operations that can execute over a SAN technology such as fibre channel. The SAN technology may allow data for different protocols to be concurrently transmitted over the same physical interface such as a host adaptor. The ULP device layer 506 may specify the mapping rules of ULPs using the protocol layers below the ULP device layer 506. For example, in a fibre channel implementation, a Small Computer System Interface (SCSI) command set may be mapped onto fibre channel by using SCSI as an upper layer protocol (ULP) above other protocol layers. Examples of ULPs that may run over fibre channel are (SCSI), Internet Protocol (IP), High Performance Parallel Interface (HIPPI), and Intelligent Peripheral Interface (EPI). ULP device module(s) in layer 506 may be part of the operating system kernel.

Specific device properties may be associated with the ULP device layer 506 and may be categorized as end target device layer properties. For example, a ULP module supporting SCSI over fibre channel may include device type, Logical Unit Number (LUN) information and capacity as properties for the ULP device layer 506.

The fabric driver may also include transport layer 507. This layer may include one or more modules that may perform generic operations such as topology discovery (e.g., loop, point-to-point, fabric, etc.), device discovery (on various topologies), handling extended link services, handling link state changes, etc. In one embodiment, the transport layer may include a fibre channel (FC) transport module 810 for each fibre channel port on the host system. Thus, for example, a ULP module in the device layer may be SCSI over the fibre channel (FC) module in the transport layer. In further embodiments, the transport layer may include an InfiniBand™ module 812 or Small Computer System Interface over IP (iSCSI) module 814. Each module may also be part of the operating system kernel.

Specific device properties may be associated with transport layer 507 and may be categorized as transport layer properties. For example, a transport channel technology may include port World Wide Name (WWN), node WWN, port address and hard address as properties of the transport layer 507. Note that specific properties may be associated with each transport channel technology within the transport layer to support the storage network environment (e.g., multiple transport layers).

The fabric driver 504 may also include host adapter (HA) drivers 508 for each host adapter/controller board on the host system. For example, FC drivers may be present for host adapters having fibre channel ports on the host system. The HA drivers 508 may be used when obtaining property information for multiple layers of device properties for each host adapter/controller board.

FIG. 6 illustrates an embodiment of the interface 503 described in FIG. 5. Specific device properties may be associated with multiple protocol layers such as ULP device layer 506 and transport layer 507. The interface 503 may include interfaces (e.g., application programming interfaces (APIs)) that may be configured to return information for a specific layer of device properties via fabric driver 504. Note that the APIs are exemplary embodiments. Other embodiments may be configured to combine the functionality of the interfaces to provide the requested information for device properties.

In one embodiment, various interfaces may be included as part of interface 503 to return property information for each of the protocol layers. A transport layers interface 610 may return a list of transport layers that may have been used during device discovery for a host computer. For example, transport layer 507 may include a fibre channel module that may have been used to discover devices for the host computer. In one embodiment, the transport information may be returned on a per host adapter basis. The following is an example of transport information that may be returned by the transport layers interface 610 for each host adapter. In one embodiment, the transport layers interface 610 may return the host adapter and transport layer information that identify the transport layer for one or more host adapters. In another embodiment, the transport layers interface 610 may return only the transport layer information, or may return other information associated to the transport layer in addition to the host adapters. In one embodiment, the transport layers interface may return an identification of one or more transport layers without providing any device property data for devices attached to the fabric.

| | |
|---|---|
| HBA port c4: | Fibre Channel port |
| | /devices/pci../pci../SUNW,qlc../fp |
| HBA port c5: | Fibre Channel port |
| | /devices/pci../pci../SUNW,qlc../fp |
| HBA port c6: | InfiniBand port |
| | /devices/ib../ib-pci-nex../qlc../fp |
| HBA port c7: | InfiniBand port |
| | /devices/ib../ib-ioc../fp |
| . . . | |
| . . . | |

In one embodiment, a property names interface 612 may be included as part of interface 503 to return property names associated with a specific protocol layer such as ULP device layer 506 and transport layer 507. The property names interface 612 may be configured to provide a list of property names for a specified transport layer of device properties. For example, for a fibre channel transport layer, the property names may be port WWN, node WWN, hard address and port address. For a ULP device layer such as SCSI over fibre channel, the property names may be device type, inquiry data, capacity data and other LUN information. The property names interface 612 may return names for the requested transport layer. In one embodiment, the property names interface may return an identification of one or more property names without providing any actual device property data for devices attached to the fabric. Property names may then be used, for example, to obtain additional property information for each property name returned by the property names interface 612.

In one embodiment, the interface 503 to the fabric driver 504 may also include a property type interface 614 to return property types for a specific property name. The property type interface 614 may be configured to provide a property type for a specified property name associated with a protocol layer such as the ULP device layer 506 and transport layer 507. The property type, which may be a data type, for example, may determine the values that the associated property name can contain and the operations that can be performed on the property type. For example, the property type may be “long integer” which has an integer data type (int) allowing arithmetic operations to be performed on the integer data type. In one embodiment, the property type may be defined by the operating system. In one embodiment, the property type may be used when manipulating actual property data that may be obtained for each property name returned by the property names interface 612. In one embodiment, the property type interface may return an identification of property type(s) without providing any device property data for devices attached to the fabric.

The interface 503 to the fabric driver 504 may also include a property data interface 616 to return actual property data for a specific property name. The property data interface 616 may be configured to provide actual property data for a specified property name associated with a protocol layer such as the ULP device layer 506 or transport layer 507. For example, property data from the transport layer and property data from the ULP device layer may be obtained separately for a specific host adaptor. The property data interface 616 may return actual data for the requested property name and type. In one embodiment, the actual data may then be linked by an anchor property to display the property data. For example, the port WWN may be used as the anchor property to link the device properties. In another embodiment, the anchor property may be used to group the device properties. For example, a specific protocol layer, such as a fibre channel transport layer, may be used to group the property information for the fibre channel transport layer.

When returning actual property data, property data interface 616 may return an error instead of the actual property data for a specific property name. In one embodiment, an error may be returned for a specified property name if an error occurred on the layer associated with the specified property name. Actual property data for a specified property name associated with a layer that does not have an error may still be returned separately although an error occurred on a different layer that does have an error. Thus, property data interface 616 may return actual property data or an error for a specific name associated with a specific layer. For example, when actual property data for a specified property name of a transport layer can be returned for a device, but actual property data for a specified property name of a ULP device layer is not available due to some end device error, the actual property data for the specified property name of the transport layer may still be returned separately by the property data interface 616. An application requesting transport layer property data may still obtain the transport layer property data although a failure or an error may be on the ULP device layer. An application requesting ULP device layer property information may obtain the error instead of actual property data for the ULP device layer. Returning an error for a specific layer may be useful when isolating and handling errors for multiple protocol layers. Although a device may be discovered at the transport layer, for example, the device may be in a state where ULP device layer operations may not be accepted or fail. In addition, the device may not accept a port-to-port login process (PLOGI) due to a hardware failure or non-existence of a ULP LUN. Also, a ULP device layer operation itself may fail due to an internal device error. In such cases, actual property data for the transport layer may still be obtained through property data interface 616.

The following example shows device property information linked using the port WWN as an anchor property. Errors for each layer of device properties are also shown. For example, the error identified as part of the SCSI (ULP device layer) properties on port WWN 210100e08b245112 is shown as part of the SCSI actual data.

HBA port c4: Fibre Channel port

/devices/pci../pci../SUNW,qlc../fp

Fibre Channel properties:

| | Hard | | |
|---|---|---|---|
| port address | address | port WWN | node WWN |
| 100100 | 0 | 210000e08b04a47c | 200000e08b04a47c |
| 100200 | 0 | 210100e08b247d12 | 200100e08b247d12 |
| 100300 | 0 | 210100e08b245112 | 200100e08b245112 |
| 100400 | 0 | 210000e08b247e12 | 200100e08b247e12 |
| 100500 | 0 | 210000e08b0104f7 | 200000e08b0104f7 |
| SCSI properties: | | | |
| | Device | | |
| port WWN | type | LUN | Device Capacity |
| 210000e08b04a47c | Disk | 0 | 12GB |
| | | 1 | 12GB |
| | | 2 | 12GB |
| 210100e08b247d12 | Disk | 0 | 172GB |

| 210100e08b245112 | Error (port login failed) | |
|---|---|---|
| 210000e08b247e12 | Tape | 0 |
| 210000e08b0104f7 | Tape | 0 |
| . . . | | |
| . . . | | |

The following shows part of a psuedo code example for obtaining actual property data from a transport layer of device properties. For each device coupled to a host adaptor, actual property data may be obtained for the transport layer of device properties. As included in the comments of the psuedo code, actual property data for the end target device layer of properties may also be obtained.

. . . .
. . . .

char **prop_name_array;
char **target_prop_name_array;
int num_of_prop;
int num_of_target_prop;
uchar *uchar_prop_data
int *int_prop_data;
char *string_prop_data;
get_transport_property_names(

hba_path, prop_name_array, num_of_prop);

get_target_property_names(hba_path,
target_prop_name_array,

num_of_target_prop);

get_device_list(hba_path);
for each device in device list do

for (i = 0; i < num_of_prop; i++) {

prop_type = get_property_type(pro_name_array[i],

error);

if (error) {

process error;

}

switch (prop_type) {
case uchar_type:

get_uchar_type_property(*prop_name_array[i],
uchar_prop_data, prop_size, error);
if (?error) {

process property data;

}

case int_type:

get_int_type_property(*prop_name_array[i],
int_prop_data, error);
if (?error) {

process property data;

}

cast string_type:

get_string_type_property(*prop_name_array[i],
str_prop_data, error);
if (?error) }

process property data;

}

. . .
. . .
}

}
/* if target device property is required
* process target device property using the same

algorithm.

*/

}
. . .
. . .

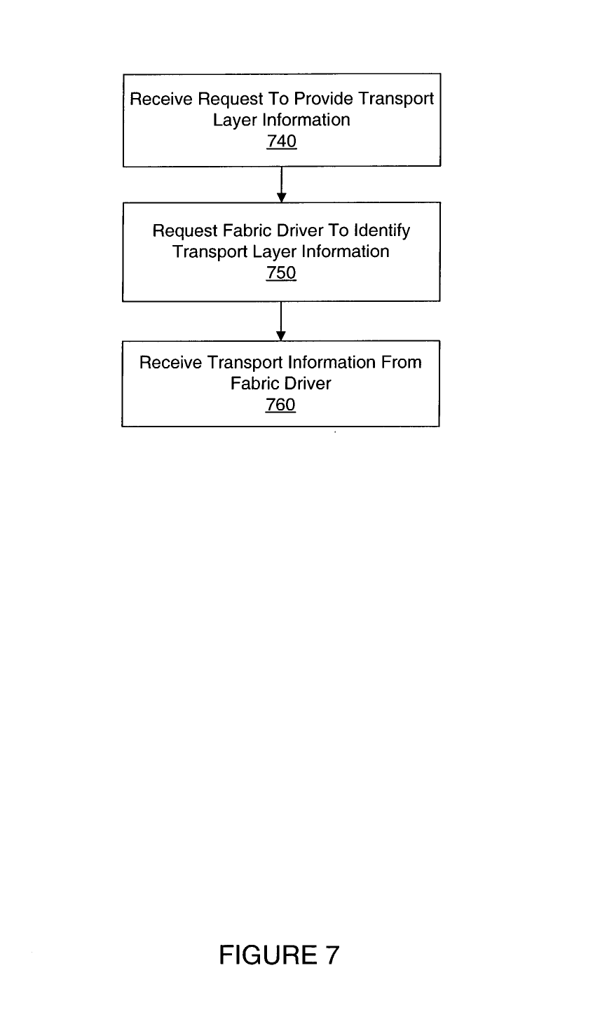

Turning to the flowchart of FIG. 7, one embodiment of a process for providing transport layers that may later be used to obtain information for multiple layers of device properties is shown. A request may be received to provide transport layer information, as indicated at 740. The request may be a request to an interface to provide the transport layer information. In response to the request to provide the transport layer information, a fabric driver may be requested to identify transport layers, as indicated at 750. In one embodiment, a device driver for communicating with a direct attach device may be requested to identify transport layers instead of, or in addition to, the fabric driver. A list of identified transport layers may be received from the fabric driver, as indicated at 760. Note that the term “list” simply refers to the information or data provided by the fabric driver. The list of transport layers may include transport layers that may have been used during device discovery for a host computer. For example, the list of transport layers may include a fibre channel transport layer that may have been used to discover devices for the host computer. In one embodiment, the list of transport layers may include the host adapter and transport layer information that identify the transport layer for one or more host adapters. In another embodiment, the list of transport layers may only include the transport layer information, or may include other information associated to the transport layer in addition to the host adapters. The list of transport layers provided may then be used to obtain information for a particular layer of device properties.

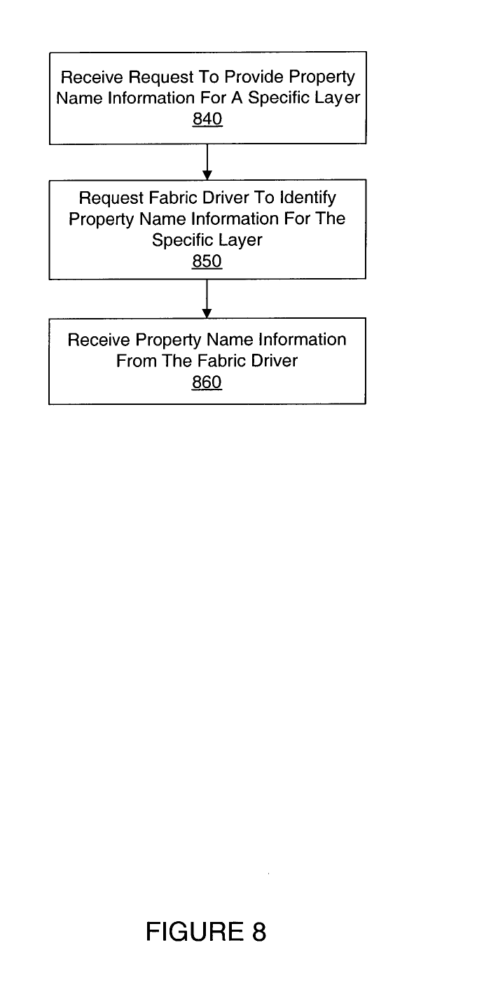

Turning to FIG. 8, a flowchart shows a method for providing property names for a specified layer of device properties according to one embodiment. A request may be received to provide property name information for a specified layer such as a transport layer or ULP device layer, as indicated at 840. For example, for a fibre channel transport layer, the property names may be port WWN, node WWN, hard address and port address. For a ULP device layer such as SCSI over fibre channel, the property names may be device type, inquiry data, capacity data and other LUN information. The request may be a request to an interface to provide the property name information. In response to the request to provide the property name information, a fabric driver may be requested to identify property names for the specified layer, as indicated at 850. In one embodiment, a device driver for communicating with a direct attach device may be requested to identify property names instead of, or in addition to, the fabric driver. A list of identified property names may be received from the fabric driver, as indicated at 860. Note that the term “list” simply refers to the information or data provided by the fabric driver. The list of property names may then be used to obtain information for a particular device property.

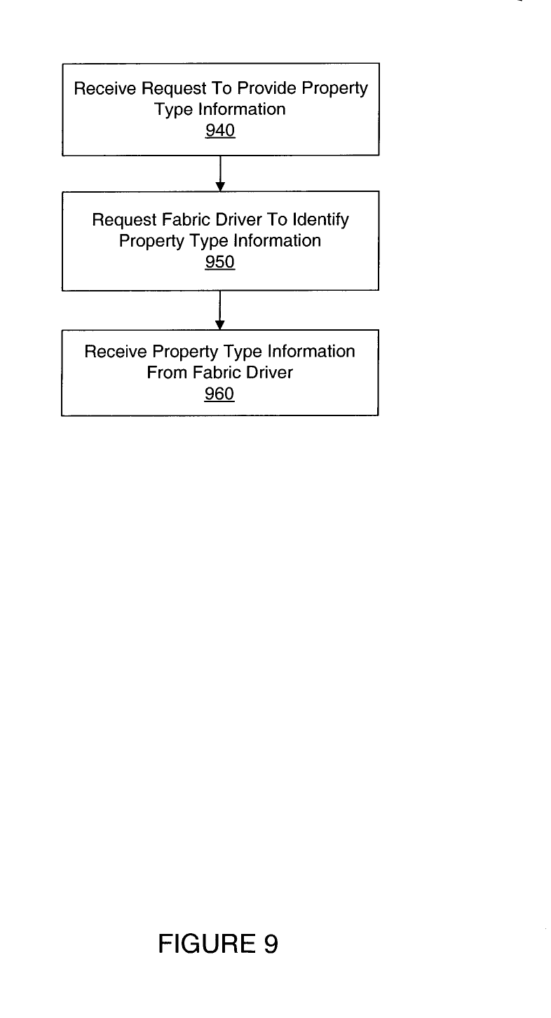

Turning to FIG. 9, a flowchart shows a method for providing property types for a specified property name according to one embodiment. A request may be received to provide property type information for a particular property name, as indicated at 940. For example, the property type may be an array of characters which has a character array data type (char x[5]) allowing string operations to be performed on the data type. The request may be a request to an interface to provide the property type information. In response to the request to provide the property type information, a fabric driver may be requested to identify property types for the property name, as indicated at 950. In one embodiment, a device driver for communicating with a direct attach device may be requested to identify property types instead of, or in addition to, the fabric driver. A list of identified property types for specified property names may be received from the fabric driver, as indicated at 960. Note that the term “list” simply refers to the information or data provided by the fabric driver. The list of property types may then be used to obtain actual property data for a particular device property.

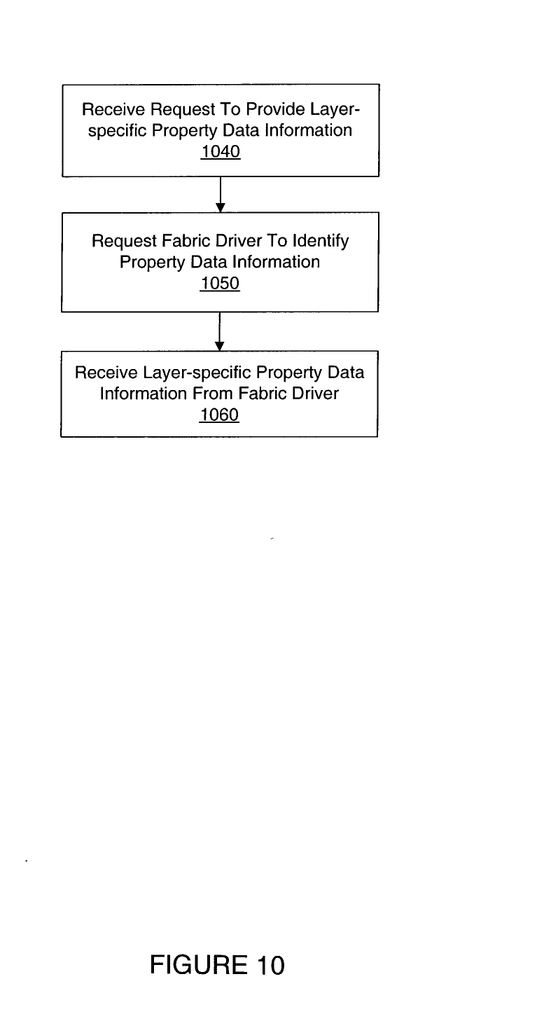

Turning to FIG. 10, one embodiment of a process for providing actual layer-specific property data information for a specific layer of multiple layers of device properties is shown. A request may be received to provide property data information for a particular property name or layer, as indicated at 1040. For example, the port address for the port WWN device property may be requested or actual property data for specified property names of a particular layer may be requested. The request may be a request to an interface to provide the property data information. In response to the request to provide the property data information, a fabric driver may be requested to identify the property data, as indicated at 1050. In one embodiment, a device driver for communicating with a direct attach device may be requested to identify property data instead of, or in addition to, the fabric driver. A list of identified property data may be received from the fabric driver, as indicated at 1060. Note that the term “list” simply refers to the information or data provided by the fabric driver. The list of property data provided may also include error information. For example, an error may be returned as part of the list of property data for a specified property name if an error occurred on the layer associated with the specified property name. Thus, the list of property data for a specified property name associated with a layer may still be returned although an error occurred on a different layer. For example, when the list of property data for a specified property name of a transport layer can be returned for a device, but the list of property data for a specified property name of a ULP device layer is not available due to some end device error, the list of property data for the specified property name of the transport layer may still be provided.

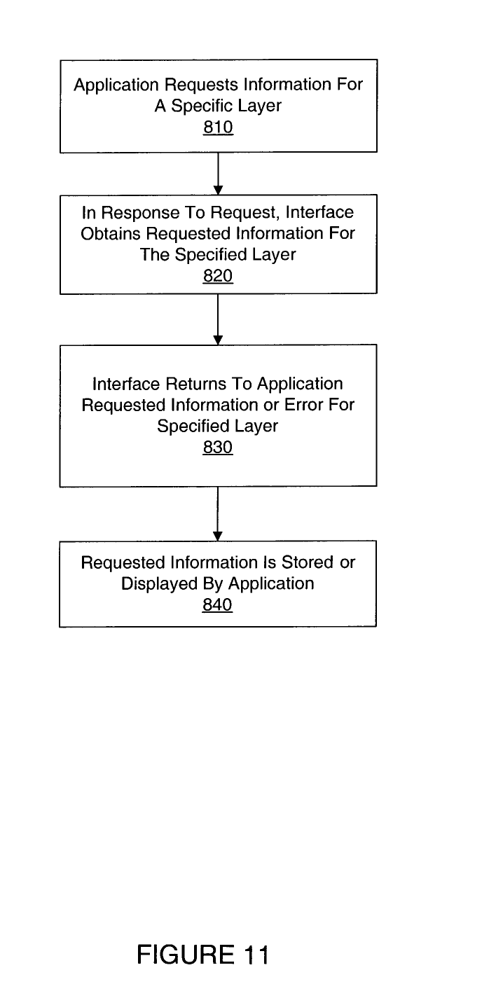

Turning to FIG. 11, a flowchart shows a method for providing property information to an application for a specified layer of device properties according to one embodiment. An application, such as a user interface with functionality for a system administrator, may request property information for a specific layer, as indicated in 810. The application may make a request for property information for a specific layer such as a transport layer. This request may have been initiated by a user using the application on the host system. In other embodiments, this process may have been initiated automatically, for example in response to an event (e.g., fibre channel protocol event) or a request from another application or process.

The request may be received by an interface from the application to provide property information for the specific layer of device properties, as indicated in 820. In response to the request to provide the property information, the application may requests interfaces (e.g., application programming interfaces (APIs)) configured to return information for a specific layer of multiple layers of device properties, to obtain the property information. Note that the interfaces (e.g., APIs) described in FIGS. 7 through 10 are exemplary embodiments. Other embodiments may be configured to combine the functionality of the interfaces to provide the property information for devices. Once the interface obtains the property information (e.g., from a fabric driver), the property information may be returned to the application for the specified layer, as indicated in 830. The property information for the specified layer may be an error or actual property data specific to the layer. Although a device may be discovered at the transport layer, for example, the device may be in a state where ULP device layer operations may not be accepted or fail. Also, a ULP device layer operation itself may fail due to an internal device error. In such cases, the property information for the transport layer, as well as the error for the ULP device layer, may still be provided to the application by one request for property information for the transport layer and a separate request for property information for the ULP device layer.

Once the application receives the property information, the property information may be stored and/or displayed via the user interface, as indicated in 840. In one embodiment, a persistent repository may store property information for different layers of device properties. In another embodiment, the property information may be parsed and only specific data of the property information may be displayed via the user interface.

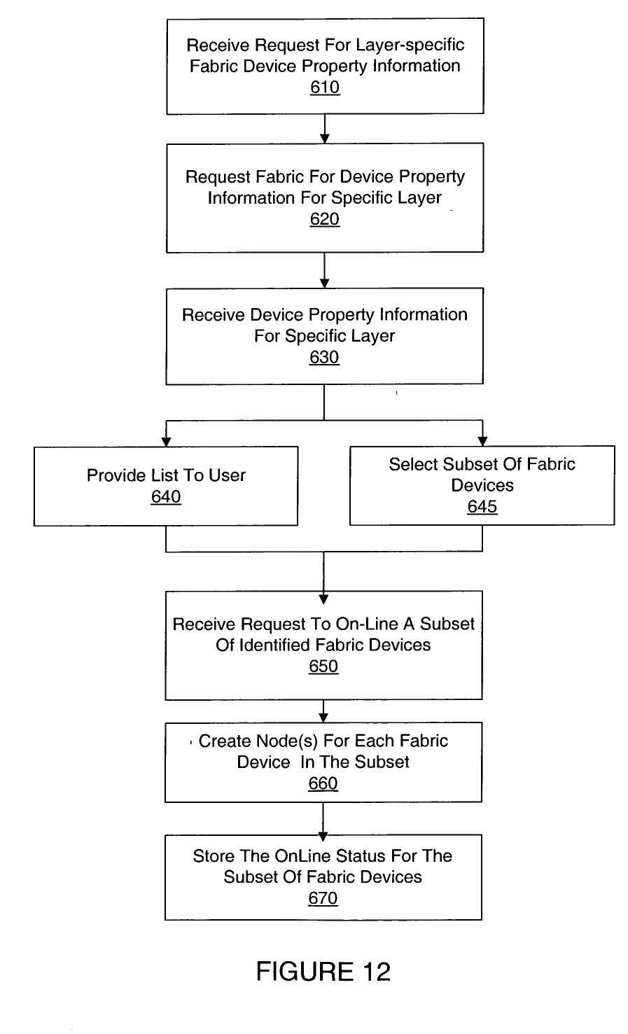

The property information may be used for managing or configuring devices corresponding to the property information, such as managing or configuring storage devices in a SAN. For example, one embodiment of an on-demand node configuration process is illustrated by the flowchart of FIG. 12 in which layer-specific device property information may be used to configure fabric devices on demand. An application may be configured to perform on-demand node configuration of the fabric devices in the SAN. A request may be received for layer-specific property information for devices, as indicated at 610. The request may be a request to the application configured to return information for a specific layer of device properties.

In response to the request for layer-specific property information for devices, the application may request interfaces (e.g., application programming interfaces (APIs)) configured to return information for a specific layer of multiple layers of device properties, to obtain the property information which may identify the fabric devices available to a host system, as indicated at 620. In one embodiment, interfaces, such as the property names interface described with FIG. 8, and the property types interface described with FIG. 9, may return the property names and types for the specific layer to the application. Other interfaces, such as the interface described with FIG. 10, may return actual property data for the specific layer of the device properties. Layer-specific property information for devices may be received from the fabric, as indicated at 630. The layer-specific property information for devices may be a list and may include identified fabric devices. Note that the term “list” simply refers to the information or data provided by the fabric driver.

This list may be provided to a user for selection of a subset of the fabric devices, as indicated at 640. Alternatively, selection of a subset of the fabric devices may be performed without user involvement, as indicated at 645. A request may be received to on-line the subset of identified fabric devices, as indicated at 650. In one embodiment, the user may select a device and request that the selected device be brought online for each path presented for the device. In response to the request to on-line the subset of identified fabric devices, a node or nodes may be created for each fabric device of the subset not already on-line, as indicated at 660. A node may provide a mechanism for processes to communicate with the corresponding device from the host system. The on-line status on each fabric device of the subset may be stored, as indicated at 670.

Note that the flow charts described herein represent exemplary embodiments of methods. The methods may be implemented in software, hardware, or a combination thereof. The order of method may be changed, and various elements may be added, reordered, combined, omitted, modified, etc. For example in FIG. 11, the application may store the property information (840) before, after or during receiving other property information (840).

Various modifications and changes may be made as would be obvious to a person skilled in the art having the benefit of this disclosure. Note also that the flow charts described herein do not necessary require a temporal order. It is intended that the following claims be interpreted to embrace all such modifications and changes and, accordingly, the specifications and drawings are to be regarded in an illustrative rather than a restrictive sense.

Various embodiments may further include receiving, sending or storing instructions and/or data implemented in accordance with the foregoing description upon a computer readable medium. Generally speaking, a computer readable medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

What is claimed is:

1. A system, comprising:
one or more host adapter ports for coupling the system to a fabric network, wherein one or more devices attached to the fabric network are discoverable to the system through the one or more host adapter ports; and
one or more processors configured to execute:
a fabric driver configured to interface the system to the fabric network through the host adapter ports, wherein the fabric driver provides access to the fabric network according to a plurality of protocol layers; and
an interface configured to provide layer-specific device property information, wherein the interface is configured to obtain device property information for the devices attached to the fabric network from the fabric driver and return the device property information specific to one of the plurality of protocol layers.

2. The system as recited in claim 1, wherein the plurality of protocol layers comprise a transport layer and an end target device layer.

3. The system as recited in claim 2, wherein the transport layer comprises at least one of a Fibre Channel transport layer, an InfiniBand transport player and an iSCSI (small computer system interface over Internet Protocol) transport layer.

4. The system as recited in claim 2, wherein the end target device layer comprises a SCSI device layer.

5. The system as recited in claim 1, wherein the interface is configured to provide an application programming interface (API) to one or more applications requesting device property information for the one or more devices attached to the fabric network.

6. The system as recited in claim 1, wherein the interface comprises a transport layers interface configured to provide an interface for providing a list of transport layers through which the one or more devices attached to the fabric network are discoverable to the system through the one or more host adapter ports.

7. The system as recited in claim 1, wherein the interface comprises a property names interface configured to provide an interface for providing property names for a specified one of the protocol layers.

8. The system as recited in claim 7, wherein for a Fibre Channel transport protocol layer, the property names returned by the property names interface comprises one or more of port world wide name (WWN), node WWN, port address and hard address.

9. The system as recited in claim 7, wherein for an end target device protocol layer, the property names returned by the property names interface comprises one or more of device type, logical unit number and storage capacity.

10. The system as recited in claim 1, wherein the interface comprises a property type interface configured to provide an interface for providing property type information for one or more property names for a specified one of the protocol layers.

11. The system as recited in claim 10, wherein the property type information returned by property type interface includes data type information for each property name.

12. The system as recited in claim 1, wherein the interface further includes a property data interface configured to provide an interface to the fabric driver for providing property data for the one or more devices attached to the fabric network, wherein the property data returned by the property data interface is for a specified one of the protocol layers.

13. The system as recited in claim 12, wherein for a Fibre Channel transport protocol layer, the property data returned by the property data interface comprises data for one or more of port world wide name (WWN), node WWN, port address and hard address for one or more of the devices attached to the fabric network.

14. The system as recited in claim 12, wherein for an end target device protocol layer, the property data returned by the property data interface comprises data for one or more of device type, logical unit number and storage capacity for one or more of the devices attached to the fabric network.

15. The system as recited in claim 12, wherein the property data interface is configured to return error information specific to a specified one of the protocol layers if an error occurs when acquiring the property data for that protocol layer.

16. The system as recited in claim 1, wherein the one or more processors are configured to execute an application configured to request layer-specific device information from the interface to manage one or more of the devices attached to the fabric network.

17. The system as recited in claim 16, wherein said application is configured to display the layer-specific device information to a user through a user interface.

18. The system as recited in claim 1, wherein the one or more processors are configured to execute an application configured to request layer-specific device property information from the interface to configure on demand one or more of the devices attached to the fabric network for access by the system.

19. The system as recited in claim 1, wherein the fabric network and one or more devices attached to the fabric network comprise a storage area network (SAN), and wherein the one or more devices attached to the fabric network comprise one or more storage devices.

20. The system as recited in claim 1, wherein the interface is further configured to provide layer-specific device property information for one or more direct-attach or local loop devices of the system.

21. A method, comprising:
receiving a request from an application for layer-specific device property information;
in response to the request, interfacing to a fabric driver to obtain layer-specific device property information for one or more devices on a fabric network, wherein the fabric driver is configured to interact with the fabric network according to a plurality of protocol layers; and
returning to the application the layer-specific device property information specific to one of the plurality of protocol layers.

22. The method as recited in claim 21, wherein the plurality of protocol layers comprise a transport layer and an end target device layer.

23. The method as recited in claim 22, wherein the transport layer comprises at least one of a Fibre Channel transport layer, an InfiniBand transport player and an iSCSI (small computer system interface over Internet Protocol) transport layer.

24. The method as recited in claim 22, wherein the end target device layer comprises a SCSI device layer.

25. The method as recited in claim 21,
wherein the request from the application comprises a request for a list of transport layers through which the one or more devices attached to the fabric network are accessible; and
wherein said returning comprises returning the list of transport layers in response to the request.

26. The method as recited in claim 21,
wherein the request from the application comprises a request for property names for a specified one of the protocol layers; and
wherein said returning comprises returning the property names in response to the request.

27. The method as recited in claim 26, wherein for a Fibre Channel transport protocol layer, the property names comprise one or more of port world wide name (WWN), node WWN, port address and hard address.

28. The method as recited in claim 26, wherein for an end target device protocol layer, the property names comprise one or more of device type, logical unit number and storage capacity.

29. The method as recited in claim 21,
wherein the request from the application comprises a request for property types for one or more property names for a specified one of the protocol layers; and
wherein said returning comprises returning property types in response to the request.

30. The method as recited in claim 21,
wherein the request from the application comprises a request for property data for the one or more devices attached to the fabric network for a specified one of the protocol layers; and
wherein said returning comprises returning property data for the one or more devices attached to the fabric network for the specified on of the protocol layers or returning error information specific to the specified one of the protocol layers if an error occurs when acquiring the property data for that protocol layer.

31. The method as recited in claim 30, wherein for a Fibre Channel transport protocol layer, the property data comprises data for one or more of port world wide name (WWN), node WWN, port address and hard address for the one or more devices attached to the fabric network.

32. The method as recited in claim 30, wherein for an end target device protocol layer, the property data comprises data for one or more of device type, logical unit number and storage capacity for the one or more devices attached to the fabric network.

33. The method as recited in claim 21,
wherein said requesting comprises requesting the layer-specific device property information from a fabric driver interface; and
displaying the layer-specific device information to a user through a user interface.

34. The method as recited in claim 33, further comprising using the layer-specific device property information returned from the fabric driver interface to configure on demand the one or more devices attached to the fabric network for access by a host system.

35. A computer accessible medium comprising instructions executable by one or more processors to provide:
access to a fabric network from a fabric driver according to a plurality of protocol layers; and
an interface to obtain layer-specific device property information, wherein the interface is configured to obtain device property information for one or more devices attached to a fabric network from the fabric driver and return the device property information specific to one of the plurality of protocol layers.

36. The computer accessible medium as recited in claim 35, wherein the plurality of protocol layers comprise a transport layer and an end target device layer.

37. The computer accessible medium as recited in claim 36, wherein the transport layer comprises at least one of a Fibre Channel transport layer, an InfiniBand transport player and an iSCSI (small computer system interface over Internet Protocol) transport layer.

38. The computer accessible medium as recited in claim 36, wherein the end target device layer comprises a SCSI device layer.

39. The computer accessible medium as recited in claim 35, wherein the interface is configured to provide an application programming interface (API) to one or more applications requesting device property information for the one or more devices attached to the fabric network.

40. The computer accessible medium as recited in claim 35, wherein the interface comprises a transport layers interface configured to provide an interface for providing a list of protocol layers through which the one or more devices attached to the fabric network are discoverable to a system through one or more host adapter ports.

41. The computer accessible medium as recited in claim 35, wherein the interface comprises a property names interface configured to provide an interface for providing property names for a specified one of the protocol layers.

42. The computer accessible medium as recited in claim 41, wherein for a Fibre Channel transport protocol layer, the property names returned by the property names interface comprises one or more of port world wide name (WWN), node WWN, port address and hard address.

43. The computer accessible medium as recited in claim 41, wherein for an end target device protocol layer, the property names returned by the property names interface comprises one or more of device type, logical unit number and storage capacity.

44. The computer accessible medium as recited in claim 35, wherein the interface comprises a property type interface configured to provide an interface for providing property type information for one or more property names for a specified one of the protocol layers.

45. The computer accessible medium as recited in claim 44, wherein the property type information returned by property type interface includes data type information for each property name.

46. The computer accessible medium as recited in claim 35, wherein the interface further includes a property data interface configured to provide an interface to the fabric driver for providing property data for the one or more devices attached to the fabric network, wherein the property data returned by the property data interface is for a specified one of the protocol layers.

47. The computer accessible medium as recited in claim 46, wherein for a Fibre Channel transport protocol layer, the property data returned by the property data interface comprises data for one or more of port world wide name (WWN), node WWN, port address and hard address for the one or more devices attached to the fabric network.

48. The computer accessible medium as recited in claim 46, wherein for an end target device protocol layer, the property data returned by the property data interface comprises data for one or more of device type, logical unit number and storage capacity for the one or more devices attached to the fabric network.

49. The computer accessible medium as recited in claim 46, wherein the property data interface is configured to return error information specific to a specified one of the protocol layers if an error occurs when acquiring the property for that protocol layer.

50. The computer accessible medium as recited in claim 35, wherein the one or more processors are configured to execute an application configured to request layer-specific device information from the interface to manage the one or more devices attached to the fabric network.

51. The computer accessible medium as recited in claim 50, wherein said application is configured to display the layer-specific device information to a user through a user interface.

52. The computer accessible medium as recited in claim 35, wherein the one or more processors are configured to execute an application configured to request layer-specific device information from the interface to configure on demand the one or more devices attached to the fabric network for access by a system.

53. The computer accessible medium as recited in claim 35, wherein the fabric network and the one or more devices attached to the fabric network comprise a storage area network (SAN), and wherein the one or more devices attached to the fabric network comprise one or more storage devices.

54. The computer accessible medium as recited in claim 35, wherein the interface is further configured to provide layer-specific device property information for one or more direct-attach or local loop devices of the system.
